(19) United States
(12) Patent Application Publication
(10) Pub. No.: US 2009/0300902 A1
(43) Pub. Date: Dec. 10, 2009

(54) COLD-ROLLED STEEL SHEET AND PROCESS FOR PRODUCING THE SAME

(75) Inventors: Nobuko Mineji, Tokyo (JP); Reiko Sugihara, Tokyo (JP); Tadashi Inoue, Tokyo (JP)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: JFE Steel Corporation, Chiyoda-ku, Tokyo (JP)

(21) Appl. No.: 12/519,539

(22) PCT Filed: Dec. 20, 2006
(86) PCT No.: PCT/JP2006/325986

§ 371 Date: Jul. 22, 2009

(51) Int. Cl. H01M 6/00; C21D 8/04; C22C 38/04

(52) U.S. Cl. 29/623.1; 148/624; 148/330

(57) ABSTRACT

A cold-rolled steel sheet that is suitable for battery cases and has low anisotropy is composed of, by mass %, C: ≦0.0030%, Si: ≦0.02%, Mn: 0.15 to 0.19%, P: ≦0.020%, S: ≦0.015%, N: ≦0.0040%, Al: 0.020 to 0.070%, Nb: 1.00≦Nb/C (atomic equivalent ratio)≦5.0, B: 1 ppm≦B-(11/14)N≦15 ppm (in the expression, B and N denote the contents of the respective elements), and the balance: being Fe and inevitable impurities, and has a planar anisotropy Δr of the r-value in the range of −0.10≦Δr≦0.10. In a process for producing the steel sheet, the cold rolling is performed at a rolling ratio of 70 to 87%, and then annealing is performed on a continuous annealing line at an annealing temperature of from the recrystallization temperature to 830° C.

### RELATED APPLICATIONS

This is a §371 of International Application No. PCT/JP2006/325986, with an international filing date of Dec. 20, 2006 (WO 2008/075444 A1, published Jun. 26, 2008).

### TECHNICAL FIELD

This disclosure relates to a cold-rolled steel sheet suitable as a material for drawing forming or DI forming and relates to a process for producing the steel sheet. Specifically, the disclosure relates to a low-anisotropic cold-rolled steel sheet that is mainly used as a steel sheet (plate) suitable for, for example, battery cases and relates to a process for producing the steel sheet.

### BACKGROUND

Since interstitial-free steels do not contain solid solute. C and N, they are basically non-aging and have excellent press formability. Therefore, the interstitial-free steels have been widely used as materials for drawing forming and DI forming, for example, as steel sheets for battery cases.

For example, a battery case is formed by combining deep drawing and ironing of a steel sheet. Specifically, the battery case is formed by, for example, DI forming in which a cup is formed by drawing and then applied to ironing; stretch draw forming in which a cup is formed by drawing and then, as needed, applied to ironing; or multi-stage drawing forming in which multi-stage drawing and then ironing are performed.

The thus produced battery cases have different heights in the can circumferential direction after working, and a large amount of debris are produced by that the irregular portions are cut out, resulting in a decrease in yield. Therefore, it is required to suppress irregularity in heights of the cases, that is, to reduce earing. The r-value (Lankford value) is known as an index indicating deep drawing properties of steel sheets such as cold-rolled steel sheets, and it is generally known that the amount of earing has a good correlation with Δr, which is an index indicating planar anisotropy of the r-value. Specifically, the amount of earing decreases as the Δr approaches zero. The Δr herein can be expressed as follows:

Δr=(r₀+r₉₀−2×r₄₅)/2.

In the equation, r₀ denotes an r-value in the rolling direction, r₄₅ denotes an r-value in the direction of 45° from the rolling direction, and r₉₀ denotes an r-value in the direction of 90° from the rolling direction. A steel sheet having a Δr in the range of −0.10 to 0.10 can be defined as a low-anisotropic steel sheet.

Steel sheets suitable for deep drawing have been practically produced by continuously annealing IF steels. For example, Japanese Unexamined Patent Application Publication No. 61-64852 proposes a low-anisotropic cold-rolled steel sheet that at least optionally contains Nb and is suitable for deep drawing. In addition, for example, Japanese Unexamined Patent Application Publication Nos. 5-287449, 2002-212673, 3-97813, and 63-310924 propose those at least optionally containing B.

We discovered that materials composed of a Nb-IF steel containing B (the IF steel are characterized by fixing, for example, solid solute C by Nb) may exhibit hot shortness (embrittlement) and have slab cracking during casting in some particular element ratios. In such a case, a step of partially scarfing a steel slab after cooling is necessary for removing defects. However, this caused the problem of reducing manufacturing efficiency.

It could therefore be helpful to provide a cold-rolled steel sheet having a low anisotropy not inducing slab cracking during continuous casting, having excellent surface properties, and being suitable for deep drawing and to provide a process for producing such a steel sheet.

### SUMMARY

We focused on component elements that affect both hot-rolling properties and anisotropy and by regulating the amounts of Mn, S, N, and B as the component elements such that the hot-rolling properties are excellent and the anisotropy is low.

We thus provide a steel sheet composed of, by mass %, C: ≦0.0030%, Si: ≦0.02%, Mn: 0.15 to 0.19%, P: ≦0.020%, S: ≦0.015%, N: ≦0.0040%, Al: 0.020 to 0.070%, Nb: 1.00≦Nb/C (atomic equivalent ratio)≦5.0, B: 1 ppm≦B-(11/14)N≦15 ppm (in the expression, B and N denote the contents of the respective elements), and the balance: being Fe and inevitable impurities. The planar anisotropy, Δr of the r-value of the steel sheet satisfies −0.10≦Δr≦0.10. The steel sheet preferably has a thickness of 0.25 mm or more and 0.50 mm or less.

The steel sheet is produced using a steel slab having the above-mentioned composition by performing soaking at a temperature of 1050 to 1300° C., hot-rolling at a finishing temperature not lower than the Ar3 transformation point, cold-rolling at a rolling ratio of 70 to 87%, and annealing on a continuous annealing line at an annealing temperature of from the recrystallization temperature to 830° C.

Soaking the steel slab may be performed by directly placing the not-cooled steel slab in a heating furnace (direct heating) or by reheating. In addition, after the hot-rolling, the steel may be pickled before the cold-rolling. Furthermore, after the annealing, temper rolling may be performed.

The steel sheet can be used for a battery case as a part of a battery. Specifically, the steel sheet may be formed into a battery case by deep drawing (including an optional process such as ironing). This battery case can be supplied to battery manufacturers.

### BRIEF DESCRIPTION OF DRAWINGS

FIG. 1 is a drawing illustrating the shape and the size of a tensile test specimen used in investigation of hot-rolling properties.

FIG. 2 is a graph showing changes in Δr (vertical axis) according to changes in cold-rolling ratio (horizontal axis:unit %) in different B contents.

### DETAILED DESCRIPTION

As described above, materials composed of Nb-IF steels containing B may exhibit hot shortness (embrittlement) and have slab cracking during casting in some particular element ratios. Such slab cracking occurs depending on, for example, the shape of a mold, casting temperature, and the viscosity of powder. In the materials composed of Nb-IF steels containing B, a predominant factor of the slab cracking is deterioration in hot-rolling properties of the steel slabs due to grain-boundary embrittlement caused by carbides, nitrides, and sulfides deposited at high temperature (900 to 1100° C.) during the casting.

That is, slab cracking can be avoided by minimizing the deterioration of the hot-rolling properties by regulating the amounts of nitrides and sulfides that are involved in the grain-boundary embrittlement in a high-temperature region.

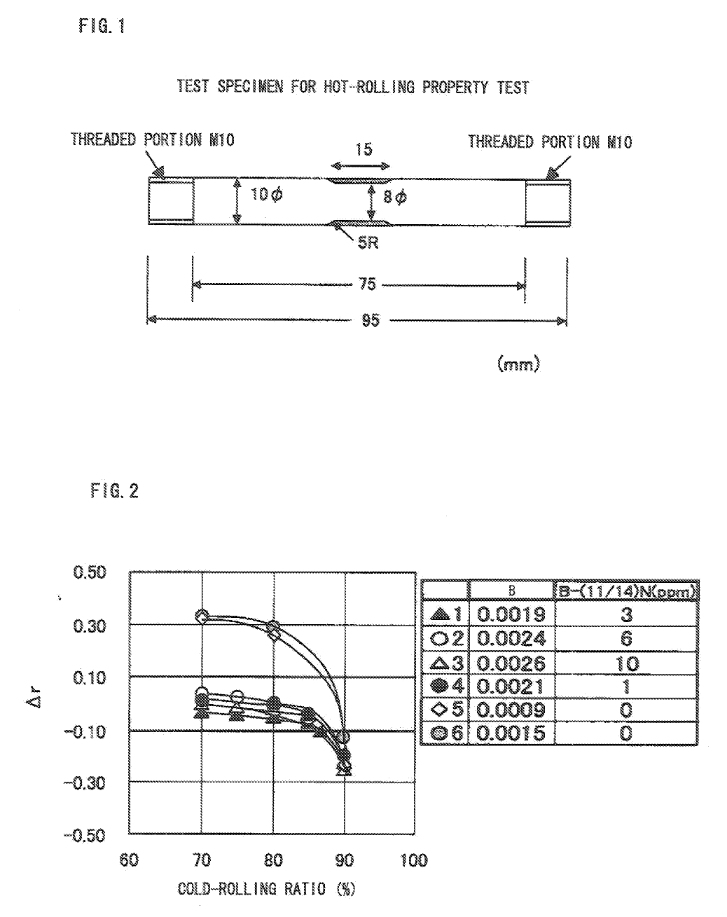

The superiority of hot-rolling properties can be determined by the value of reduction of area (%) in a high-temperature tensile test. Accordingly, we investigated conditions of steel cracking in detail by using values of reduction of area. FIG. 1 shows the shape and the size of a tensile test specimen for measuring a value of reduction of area. The test specimen has a cylindrical shape having a diameter of 10 mm and a length of 95 mm (75 mm excluding the threaded portions M10 at both ends). The specimen has a testing portion having a diameter of 8 mm and a length of 15 mm at the center thereof. The radius R of the corner for reducing the diameter is 5 mm.

We discovered that no slab cracking occurs when the value of reduction of area is 40% or more in the high-temperature tensile test at 950° C. In addition, we found that to avoid casting cracking, as described above, it is important to avoid deterioration of hot-rolling properties of the steel slab due to grain boundary embrittlement caused by carbides, nitrides, or sulfides, and it is also important to regulate, in particular, the amounts of BN and MnS in the element composite.

On the other hand, the cold-rolling ratio highly affects anisotropy, and strict regulation of the rolling ratio is highly required for obtaining a low-anisotropic steel sheet having a Δr of −0.10 to 0.10. That is, in the IF steel, the r-value and the Δr are dominantly affected by crystal orientation distribution (recrystallization texture) of recrystallized grains after annealing. The orientation distribution of recrystallized grains is highly affected by cold-rolled texture formed in the steel sheet during the cold-rolling. As a matter of course, the cold-rolled texture is highly affected by the cold-rolling ratio. Therefore, in general, the Δr sensitively varies depending on the cold-rolling ratio.

However, for example, considering the equipment load and the manufacturing ratio, it is not realistic to strictly regulate the rolling ratio for adjusting the Δr within a predetermined range. Accordingly, it is desired to reduce the influence of the cold-rolling ratio on the anisotropy. The investigation regarding the anisotropy has revealed that the presence of solid-solute B is very effective. That is, it has been found that a low-anisotropic steel sheet can be readily produced by reducing the influence of the cold-rolling ratio by giving solid-solute B by regulating the B content according to the N content in the steel.

As described above, to give a low-anisotropic steel sheet, the steel has to contain B. On the other hand, to avoid slab cracking, precipitation of BN has to be suppressed as much as possible. Various investigations have been conducted for solving this problem, and, as a result, the steel successfully satisfies the conflicting requirements by the following means.

That is, as described above, the slab cracking is mainly caused by precipitation of BN, MnS, or complexes thereof at grain boundaries in the steel during continuous casting. Accordingly, first of all, regulation is conducted such that the precipitation of MnS is suppressed as much as possible. At the same time, regarding the precipitation of BN, the B content that forms BN is regulated to 0.0031% or less by regulating the N content to 0.0040% or less for suppressing hot shortness. As a result, an element system for ensuring solid-solute B is structured.

### Composition of Steel Sheet

That is, the steel sheet is composed of C: ≦0.0030% (mass %, hereinafter the same), Si: ≦0.02%, Mn: 0.15 to 0.19%, P: ≦0.020%, S: ≦0.015%, N: ≦0.0040%, Al: 0.020 to 0.070%, Nb: 1.00≦Nb/C (atomic equivalent ratio)≦5.0, B: 1 ppm≦B-(11/14)N≦15 ppm (in the expression, B and N denote the contents of the respective elements), and the balance: being Fe and inevitable impurities. The reasons for limiting the chemical elements of the steel sheet will be described below.

C: 0.0030% or less

A smaller amount of C provides softness and good stretch properties and is therefore advantageous for press workability.

In addition, the deposition of solid-solute C as carbides inhibits strain aging hardening due to the solid-solute C and enhances deep drawing properties, but when the content of C is excessive, it is difficult to precipitate all the C as carbides by adding Nb. As a result, deteriorations in the hardening and the stretch properties are caused by the solid-solute C. From the above, the C content in the steel sheet is regulated to be 0.0030% or less. In addition, the lower limit of the C content that can be industrially achieved is about 0.0001%.

Si: 0.02% or less

Si is an impurity element that is inevitably contained. Since a Si content greater than 0.02% causes hardening and deterioration in plating properties, the Si content in the steel is regulated to 0.02% or less. In addition, the lower limit of the Si content that can be industrially achieved is about 0.001%.

Mn: 0.15% or more and 0.19% or less

Mn is an effective element for preventing hot shortness due to S during hot rolling and is therefore necessary to be contained at least 0.15%. However, as described above, Nb-IF steels containing B, as in the steel, have a problem of slab cracking. Therefore, when the Mn content is higher than 0.19%, MnS is excessively precipitated during continuous casting and causes hot shortness, resulting in slab cracking. In addition, excess Mn that is not precipitated as MnS becomes solid-solute Mn to increase steel strength and deteriorate rolling properties. Furthermore, the recrystallization temperature is increased by the presence of the solid-solute Mn, and thereby the load in annealing is increased. From the above, the Mn content in the steel is regulated to 0.15% or more and 0.19% or less.

P: 0.020% or less

P is an impurity element that is inevitably contained. Since a P content greater than 0.020% causes hardening to deteriorate the workability, the P content in the steel is regulated to 0.0200% or less. In addition, the lower limit of the P content that can be industrially achieved is about 0.001%.

S: 0.015% or less

S is an element that is inevitably contained. S is an impurity element that causes hot shortness during hot rolling and is also a factor that causes hot shortness when it is precipitated as MnS during continuous casting, resulting in slab cracking. Therefore, the S content as small as possible is preferred. Consequently, the S content in the steel is regulated to 0.015% or less. In addition, the lower limit of the S content that can be industrially achieved is about 0.0001%.

N: 0.0040% or less

N is an impurity element that is inevitably contained. A high N content is a factor of hot shortness due to precipitation of AlN and BN during continuous casting, resulting in slab cracking. In addition, N affects the solid-solute B amount, which affects dependency of anisotropy on the cold-rolling ratio, to increase the anisotropy.

Therefore, N is an important element, and the N content is needed to be decreased, but is acceptable by 0.0040%. By the above-described reasons, the N content in the steel is regulated to 0.0040% or less and preferably 0.0030% or less. In addition, the lower limit of the N content that can be industrially achieved is about 0.0001%.

Al: 0.020% or more and 0.070% or less

Al is an element necessary for deacidification in steelmaking, and the content thereof is preferably 0.020% or more. On the other hand, an excess amount thereof increases inclusion to readily cause surface defects. From the above, the Al content in the steel is regulated to 0.020% or more and 0.070% at most.

Nb: 1.00≦Nb/C (atomic equivalent ratio)≦5.0

Since Nb precipitates solid-solute C in the steel as carbides to suppress deterioration in deep drawing properties due to solid-solute C, the Nb content is regulated so as to be equivalent to or greater than the C content, that is, a Nb/C (atomic equivalent ratio) of 1.00 or more is satisfied. On the other hand, since an excess content thereof increases the recrystallization temperature, the content is regulated such that the Nb/C (atomic equivalent ratio) is 5.0 or less. From the above, the Nb content in the steel is regulated such that the Nb/C (atomic equivalent ratio) is within the range of 1.00 or more and 5.0 or less.

In addition, the atomic equivalent ratio is calculated by the following expression:

Nb/C(atomic equivalent ratio)=[Nb content(mass %)/93]/[C content (mass %)/12]

B: 1 ppm≦B-(11/14)N≦15 ppm

Regulation of the B content is very important.

To investigate the variation of planar anisotropy caused by changes in the ratio of a B content to a N content, the following experiment was performed.

Steels composed of C: ≦0.0018 to 0.0025%, Si: ≦0.01%, Mn: 0.19%, P: 0.008 to 0.010%, S: 0.009 to 0.011%, N: ≦0.0020 to 0.0025%, Al: 0.038 to 0.048%, Nb: 0.023 to 0.025%, and the balance: being Fe and inevitable impurities were held at a holding temperature of 1250° C. and then hot rolled at a hot-rolling finishing temperature of 900° C. Subsequently, the cold-rolling was performed at different cold-rolling ratios, followed by annealing. The resulting annealed plates were measured for Δr to investigate changes caused by the variation of cold-rolling ratio. FIG. 2 shows the results.

In FIG. 2, the horizontal axis represents the cold-rolling ratio (%) that is determined by: cold-rolling ratio (%)=100×{(thickness before cold-rolling)−(thickness after cold-rolling)}/(thickness before cold-rolling). The vertical axis represents Δr (no unit) that is determined for each of the obtained steel sheet using a No. 13 B test piece specified in JIS Z 2201 by: Δr=(r₀+r₉₀−2×r₄₅)/2, wherein r₀, r₄₅, and r₉₀ are r-values measured according to JIS Z 2241 in three directions of parallel, 45°, and 90° to the rolling direction, respectively. Symbols in the graph represent the results of steel sheets of which B contents (mass %) and B-(11/14)N (mass ppm) are ▴: 0.0019%, 3 ppm, ◯: 0.0024%, 6 ppm, Δ: 0.0026%, 10 ppm, (black): 0.0021%, 1 ppm, ♦: 0.0009%, less than 0 ppm, and (gray): 0.0015%, less than 0 ppm (corresponding to the steels, Nos. 1 to 6, in Table 1 shown below). In B-(11/14)N, N and B denote the B content (mass ppm) and the N content (mass ppm), respectively, in the steel.

FIG. 2 shows that when the value of B-(11/14)N is regulated to 1 ppm or more, the variation in Δr is very small even if the cold-rolling ratio is changed, that is, the dependency of Δr on cold-rolling ratio is extremely reduced.

That is, when the B content is regulated such that the value of B-(11/14)N is 1 ppm or more, the B content is equivalent to or greater than the N content to ensure solid-solute B. As a result, although the detailed mechanism is unclear, the dependency of Δr on cold-rolling ratio is extremely reduced, and therefore manufacturing conditions in the cold-rolling ratio can be broadened.

On the other hand, as confirmed by FIG. 2, a solid-solute B content greater than 1 ppm does not significantly improve the dependency of Δr on cold-rolling ratio. An excess content of solid-solute B increases the recrystallization temperature and, therefore, requires the recrystallization annealing temperature after cold rolling to be set to higher temperature. This is undesirable from the viewpoint of manufacturing cost. Therefore, the B content is regulated such that B-(11/14)N is 15 ppm or less. In addition, in facilities having high hit accuracy of steel elements, B-(11/14)N is preferably less than 10 ppm and more preferably less than 5 ppm for further decreasing recrystallization temperature. We discovered that a value of B-(11/14)N higher than 15 ppm increases the recrystallization temperature by about 130° C., but a value of 15 ppm or less can suppress the increase to about 100° C. or less, a value less than 10 ppm can suppress the increase to about 70° C. or less, and a value less than 5 ppm can suppress the increase to about 40° C. or less.

The balance other then the above-mentioned elements is composed of Fe and inevitable impurities. Various elements such as Sn, Pb, Cu, Mo, V, Zr, Ca, Sb, Te, As, Mg, Na, Ni, Cr, Ti, and rare earth elements (REM) may be contained as impurities during the manufacturing process in a total amount of about 0.5% or less. Such an amount of impurities do not affect the effects of the steel sheet.

### Structure of Steel Sheet

The steel sheet has a Δr of −0.10 or more and 0.10 or less, that is, an absolute Δr of 0.10 or less. Earing during fabrication of the steel sheet into, for example, a battery case can be significantly reduced by regulating the Δr to this range. The Δr of the steel sheet can be regulated by employing the above-mentioned composition of the steel sheet and a production process described below.

The steel sheet preferably has a thickness of 0.25 mm or more and 0.50 mm or less. Efforts for reducing planar anisotropy have been made mainly in the fields of steel sheets (thickness: 0.2 mm or less) for cans or cold-rolled steel sheets (thickness: 0.7 mm or more) for deep drawing for, for example, automobiles. However, there have been few studies conducted on optimization of Δr, in particular, in connection with the cold-rolling ratio in the thickness range of 0.25 to 0.50 mm, which is the optimum thickness for battery cases. The steel sheet mostly exhibit the effect thereof, in particular, in such thickness range.

### Production Process

Next, the reasons for limiting the conditions for producing a steel sheet having small anisotropy will be described.

A steel having an element composition defined above is made into an ingot. The ingot is cast into a slab by continuous casting, followed by hot rolling.

The slab prepared by the continuous casting may be hot-rolled directly or after slight heating (what is called direct charge or hot charge). Alternatively, the slab may be cooled once and then reheated for rolling.

The reheating temperature is 1050° C. or more and 1300° C. or less. The heating temperature for slightly heating the slab before getting cold is the same. When the slab is directly rolled, the rolling is preferably started within the above-mentioned temperature range.

The hot-rolling finishing temperature is not lower than the Ar3 transformation point. That is, a hot-rolling finishing temperature that is not lower than the Ar3 transformation point is necessary for providing a uniform crystal grain diameter after the rolling and for providing the hot plate with low anisotropy.

Furthermore, in the heating above, a heating temperature lower than 1050° C. is difficult to give a hot-rolling finishing temperature of the Ar3 transformation point or more, and a heating temperature higher than 1300° C. increases the amount of oxides generated on the surface of the slab, which readily causes surface defects due to the oxides and is therefore undesirable.

Then, the hot-rolled steel sheet is pickled as necessary and then cold-rolled at a cold-rolling ratio of 70% or more and 87% or less.

The pickling is a general process for removing surface scale of a hot-rolled steel sheet and may be performed with an acid such as sulfuric acid or hydrochloric acid. After the pickling, cold rolling is conducted.

A cold-rolling ratio less than 70% gives coarse crystal grains after the recrystallization annealing, which readily causes orange peel during the fabrication of cans and is therefore undesirable. In addition, a cold-rolling ratio higher than 87% gives a Δr of a large absolute value to increase the anisotropy. Therefore, the cold-rolling ratio is regulated to 70% or more and 87% or less.

Subsequently, annealing on a continuous annealing line at an annealing temperature of the recrystallization temperature or more is necessary. An annealing temperature of lower than the recrystallization temperature keeps the steel sheet hard and makes uniform fabrication difficult. On the other hand, an annealing temperature of higher than 830° C. allows the C fixed by Nb to be solid-soluted again, which deteriorates deep drawing properties, and forms coarse crystal grains, which has a risk that orange peel readily occur high, and is therefore undesirable. Therefore, the upper limit is determined to 830° C.

A steel sheet having a thickness of about 0.25 to 0.50 mm is too thin and has a risk of being broken when it passes through a continuous annealing furnace for a deep drawing steel sheet that can be annealed at high temperature. Therefore, in many of steel sheets for cans, a continuous annealing furnace with a relatively low heating ability is used. Also from this viewpoint, continuous annealing at a temperature higher than 830° C. is accompanied by a difficulty involved in facilities and is therefore undesirable.

Also from any of the viewpoints, it is further preferable that the upper limit of the annealing temperature be 830° C. or less.

In addition, the annealing time is preferably about 30 to 120 seconds.

After the annealing, to adjust the shape and the surface roughness of the steel sheet, temper rolling may be performed. The extension ratio (also called “elongation ratio”) in the temper rolling is not particularly specified, but is preferably in the range of 0.3 to 2.0% as usually performed.

### Application of Steel Sheet

The steel sheet is produced as described above and, as necessary, may be plated with Ni, Sn, Cr, or an alloy of these metals. Alternatively, diffusion annealing for diffusion alloy plating may be performed after plating. Furthermore, another surface coating, such as a resin coating, may be provided depending on the purpose. The steel sheet is generally subjected to a forming process, but may be provided with the above-mentioned various surface treatments or resin coating and then subjected to a forming process. Alternatively, after a forming process, various surface treatments or resin coating may be performed.

The steel sheet is particularly suitable for application to battery cases as battery parts, and the battery cases can be produced with a high steel sheet yield. The type of battery (chemical battery) to which the steel sheet can be applied is not particularly limited, and examples of the battery include dry batteries and secondary batteries (such as lithium ion batteries, nickel hydrogen batteries, and nickel cadmium batteries). In particular, the steel sheet can be preferably applied to those that are formed into a cylindrical shape with a diameter of about 10 to 30 mm (or further formed into a square tubular shape).

The battery cases can be produced by any of the above-described various fabrication techniques such as DI forming. In the production of a battery, the battery case is charged or loaded with a positive-electrode material, a negative-electrode material, a separator, and other necessary materials or members such as terminals.

### EXAMPLES

### Example 1

Steel slabs having compositions shown in Table 1 were produced. In Table 1, steels of Nos. 1 to 4 satisfy our component conditions, and steels of Nos. 5 to 8 do not satisfy our component conditions.

Then, the steel slabs produced above were investigated for hot-rolling properties. The investigation for hot-rolling properties was performed by a high-temperature tensile test by sampling a cylindrical tensile test specimen from each of the produced steel slabs, heating the specimen to a heating temperature once, and then cooling to the test temperature. The specimen used for the tensile test had a shape shown in FIG. 1. In the high-temperature tensile test, the value (%) of reduction of area after break, which defined by the following expression, was measured according to JIS Z 2241, and the steels with a value of 40% or more were determined to be acceptable.

Value (%) of reduction of area=100×[(initial cross-sectional area)−(minimum cross-sectional area after drawing)]/(initial cross-sectional area).

The test conditions herein are shown below.

High-temperature tensile test conditions:
heating temperature (SRT): 1420° C.,
heating temperature holding time: 60 seconds,
(tensile) test temperature: 950° C.,
test temperature holding time: 60 seconds,
strain rate: 2×10⁻³/sec.

Table 2 shows the results.

TABLE 1

| | | | | | | | | | | | B- |
|---|---|---|---|---|---|---|---|---|---|---|---|
| Steel | Chemical element (mass %) | | | | | | | | | | (11/14)N |
| No. | C | Si | Mn | P | S | N | Al | Nb | B | Nb/C | (ppm) |
| 1 | 0.0022 | 0.01 | 0.19 | 0.008 | 0.009 | 0.0020 | 0.038 | 0.024 | 0.0019 | 1.4 | 3 |
| 2 | 0.0018 | 0.01 | 0.19 | 0.010 | 0.011 | 0.0023 | 0.048 | 0.025 | 0.0024 | 1.8 | 6 |
| 3 | 0.0025 | 0.01 | 0.19 | 0.009 | 0.011 | 0.0020 | 0.045 | 0.024 | 0.0026 | 1.2 | 10 |
| 4 | 0.0020 | 0.01 | 0.18 | 0.009 | 0.010 | 0.0025 | 0.040 | 0.023 | 0.0021 | 1.5 | 1 |
| 5 | 0.0018 | tr.* | 0.18 | 0.010 | 0.011 | 0.0021 | 0.045 | 0.025 | 0.0009 | 1.8 | <0 |
| 6 | 0.0022 | 0.01 | 0.19 | 0.008 | 0.009 | 0.0021 | 0.039 | 0.023 | 0.0015 | 1.3 | <0 |
| 7 | 0.0020 | tr.* | 0.30 | 0.009 | 0.018 | 0.0024 | 0.044 | 0.024 | 0.0015 | 1.5 | <0 |
| 8 | 0.0019 | 0.01 | 0.19 | 0.009 | 0.010 | 0.0042 | 0.040 | 0.025 | 0.0062 | 1.7 | 29 |
| 9 | 0.0021 | 0.01 | 0.19 | 0.008 | 0.009 | 0.0020 | 0.038 | 0.024 | 0.0034 | 1.5 | 18 |

*tr.: below the lower limit of determination (Si < 0.008%)

TABLE 2

| | | Hot-rolling property | | |
|---|---|---|---|---|
| | | Value (%) of | | |
| Steel | Recrystallization | reduction of | | |
| No. | temperature (° C.) | area | Result | Category |
| 1 | 750 | 60 | pass | Inventive Example |
| 2 | 770 | 45 | pass | Inventive Example |
| 3 | 780 | 50 | pass | Inventive Example |
| 4 | 730 | 70 | pass | Inventive Example |
| 5 | 710 | 85 | pass | Comparative Example |
| 6 | 710 | 80 | pass | Comparative Example |
| 7 | — | 35 | fail | Comparative Example |
| 8 | — | 28 | fail | Comparative Example |
| 9 | 860 | 45 | pass | Comparative Example |

Next, only steel slabs that were: determined to have acceptable hot-rolling properties were hot-rolled. The hot-rolling conditions were a soaking temperature of 1250° C. and a hot-rolling finishing temperature of 900° C. The Ar3 transformation temperatures of the materials subjected to the hot rolling were all 880° C. The Ar3 transformation temperature herein was determined by examining a temperature at which a specimen was thermally expanded when the specimen heated in a Formaster test was annealed at around the Ar3 transformation temperature.

The hot-rolled steel sheets were cold rolled under conditions shown in Table 3 and were subjected to recrystallization annealing, followed by temper rolling at an extension ratio of 0.5%. The resulting steel sheets had thicknesses within the range of 0.20 to 0.70 mm (the thicknesses of the steel sheets at cold-rolling ratios within our range were 0.26 to 0.60 mm).

The recrystallization temperatures shown in Table 2 were determined by Vickers hardness investigation and metal structure observation. Since the recrystallization temperature decreases with the cold-rolling ratio, the Vickers hardness (JIS Z 2244) was measured at a half-thickness position of a cross section in the thickness direction with a load (test force) of 1.961 N (200 gf) after the steel sheets were heated to various temperatures for 45 seconds after cold rolling by 70%, at which the recrystallization temperature was the lowest. The heat treatment temperatures were set at every to 10° C. from 700° C. In general, a cold-rolled steel sheet, when it is heat-treated, exhibits a sharp decrease in hardness due to progress of recrystallization in a particular temperature range. The temperature at which the sharp decrease in hardness was terminated was examined, and the lowest temperature at which 100% of recrystallization in metal structure was observed was determined as the recrystallization temperature.

Then, the cold-rolled steel sheets obtained above were investigated for anisotropy. In the investigation of anisotropy, r₀, r₄₅, and r₉₀, which are r-values in three directions of parallel, 45°, and 90° to the rolling direction, respectively, of each of the obtained steel sheets were measured according to JIS Z 2241 using a No. 13 B test piece specified in JIS Z 2201, and steel sheets having a Δr within the range of +/−0.10, wherein Δr=(r₀+r₉₀−2×r₄₅)/2, were determined to be acceptable.

Table 3 also shows the results.

TABLE 3

| | | Cold- | | | | | |
|---|---|---|---|---|---|---|---|
| | | rolling | Annealing | | | | |
| | Steel | ratio | temp. | | | | |
| No. | No. | (%) | (° C.) | Δr | | Notes | Category |
| 1 | 1 | 70 | 810 | −0.03 | pass | | Inventive Example |
| 2 | 1 | 75 | 810 | −0.04 | pass | | Inventive Example |
| 3 | 1 | 80 | 810 | −0.05 | pass | | Inventive Example |
| 4 | 1 | 85 | 810 | −0.07 | pass | | Inventive Example |
| 5 | 1 | 87 | 810 | −0.10 | pass | | Inventive Example |
| 6 | 2 | 70 | 820 | 0.03 | pass | | Inventive Example |
| 7 | 2 | 75 | 820 | 0.02 | pass | | Inventive Example |
| 8 | 2 | 80 | 820 | −0.01 | pass | | Inventive Example |
| 9 | 2 | 85 | 820 | −0.05 | pass | | Inventive Example |
| 10 | 3 | 70 | 830 | 0.00 | pass | | Inventive Example |
| 11 | 3 | 75 | 830 | −0.01 | pass | | Inventive Example |
| 12 | 3 | 80 | 830 | −0.02 | pass | | Inventive Example |
| 13 | 3 | 85 | 830 | −0.04 | pass | | Inventive Example |
| 14 | 4 | 70 | 810 | 0.01 | pass | | Inventive Example |
| 15 | 4 | 80 | 810 | 0.00 | pass | | Inventive Example |
| 16 | 4 | 85 | 810 | −0.04 | pass | | Inventive Example |
| 17 | 1 | 90 | 810 | −0.23 | fail | | Comparative Example |
| 18 | 2 | 90 | 820 | −0.25 | fail | | Comparative Example |
| 19 | 3 | 90 | 850 | −0.25 | fail | | Comparative Example |
| 20 | 4 | 90 | 810 | −0.20 | fail | | Comparative Example |
| 21 | 5 | 70 | 720 | 0.32 | fail | | Comparative Example |
| 22 | 5 | 80 | 720 | 0.26 | fail | | Comparative Example |
| 23 | 5 | 90 | 720 | −0.23 | fail | | Comparative Example |
| 24 | 6 | 70 | 720 | 0.33 | fail | | Comparative Example |
| 25 | 6 | 80 | 720 | 0.29 | fail | | Comparative Example |
| 26 | 6 | 90 | 720 | −0.13 | fail | | Comparative Example |
| 27 | 1 | 65 | 810 | −0.01 | pass | orange peel | Comparative Example |
| 28 | 1 | 80 | 770 | −0.04 | pass | | Inventive Example |
| 29 | 1 | 80 | 830 | −0.03 | pass | | Inventive Example |
| 30 | 1 | 80 | 850 | −0.03 | pass | wrinkles occurred | Comparative Example |
| | | | | | | during working | |
| 31 | 1 | 80 | 810 | −0.04 | pass | SRT: 1100° C. | Inventive Example |
| 32 | 9 | 80 | 830 | −0.01 | pass | hardness: mold | Comparative Example |
| | | | | | | was damaged | |
| | | | | | | during working | |

As shown in Table 3, in our steel sheets, the Δr is within +/−0.10, the dependency of Δr on cold-rolling ratio is low, the variation in Δr due to changes in production conditions is small, and the anisotropy is low.

On the other hand, in the steel sheets of Comparative Examples, the Δr is 0.26 to 0.33 or −0.13 to −0.25, the dependency of Δr on cold-rolling ratio is high, and the variation in Δr due to changes in production conditions is large. Therefore, it can be confirmed that the steel sheets are inferior in the anisotropy.

In addition, the production conditions being outside the suitable range cause problems such as occurrence of orange peel and wrinkles and an increase in hardness, which makes, in particular, ironing difficult. The presence of the orange peel and the wrinkle was observed with naked eyes.

### Example 2

Steel slabs including the elements shown in Table 4 were produced and were investigated for the hot-rolling properties and the Ar3 transformation temperature by the same methods as in Example 1 (described in Table 5). The Ar3 transformation temperature of ach steel was within the range of 720 to 860° C.

Then, only steel slabs determined to have acceptable hot-rolling properties were hot-rolled and then cold rolled under conditions shown in Table 6, followed by recrystallization annealing and temper rolling. The conditions other than those shown in Table 6 were the same as those in Example 1. The recrystallization temperature was investigated by the same method as in Example 1, and the results are shown in Table 5.

TABLE 4

| | | | | | | | | | | | B- |
|---|---|---|---|---|---|---|---|---|---|---|---|
| Steel | Chemical element (mass %) | | | | | | | | | | (11/14)N |
| No. | C | Si | Mn | P | S | N | Al | Nb | B | Nb/C | (ppm) |
| 11 | 0.0020 | 0.01 | 0.18 | 0.009 | 0.010 | 0.0015 | 0.045 | 0.019 | 0.0015 | 1.2 | 3 |
| 12 | 0.0020 | 0.01 | 0.18 | 0.009 | 0.009 | 0.0025 | 0.040 | 0.020 | 0.0024 | 1.3 | 4 |
| 13 | 0.0019 | 0.01 | 0.19 | 0.009 | 0.011 | 0.0035 | 0.043 | 0.020 | 0.0031 | 1.4 | 4 |
| 14 | 0.0020 | 0.01 | 0.17 | 0.010 | 0.011 | 0.0044 | 0.045 | 0.018 | 0.0039 | 1.2 | 4 |
| 15 | 0.0019 | 0.01 | 0.18 | 0.010 | 0.009 | 0.0010 | 0.042 | 0.019 | 0.0025 | 1.3 | 17 |
| 16 | 0.0019 | 0.01 | 0.18 | 0.010 | 0.009 | 0.0027 | 0.044 | 0.019 | 0.0020 | 1.3 | <0 |
| 17 | 0.0019 | 0.01 | 0.18 | 0.010 | 0.009 | 0.0020 | 0.042 | 0.014 | 0.0019 | 0.95 | 3 |
| 18 | 0.0020 | 0.01 | 0.17 | 0.009 | 0.010 | 0.0020 | 0.045 | 0.017 | 0.0020 | 1.1 | 4 |
| 19 | 0.0019 | 0.01 | 0.18 | 0.009 | 0.009 | 0.0019 | 0.040 | 0.025 | 0.0018 | 1.7 | 3 |
| 20 | 0.0019 | 0.01 | 0.18 | 0.009 | 0.011 | 0.0020 | 0.043 | 0.040 | 0.0020 | 2.7 | 4 |
| 21 | 0.0017 | 0.01 | 0.17 | 0.010 | 0.011 | 0.0021 | 0.045 | 0.055 | 0.0020 | 4.2 | 4 |
| 22 | 0.0018 | 0.01 | 0.19 | 0.008 | 0.009 | 0.0020 | 0.039 | 0.072 | 0.0019 | 5.2 | 3 |
| 23 | 0.0018 | 0.01 | 0.13 | 0.009 | 0.010 | 0.0021 | 0.041 | 0.017 | 0.0020 | 1.2 | 4 |
| 24 | 0.0016 | tr.* | 0.17 | 0.010 | 0.010 | 0.0018 | 0.042 | 0.016 | 0.0017 | 1.3 | 3 |
| 25 | 0.0017 | 0.01 | 0.21 | 0.009 | 0.010 | 0.0020 | 0.040 | 0.017 | 0.0019 | 1.3 | 3 |
| 26 | 0.0017 | 0.01 | 0.18 | 0.010 | 0.003 | 0.0019 | 0.036 | 0.017 | 0.0019 | 1.3 | 4 |
| 27 | 0.0018 | 0.01 | 0.18 | 0.010 | 0.012 | 0.0019 | 0.038 | 0.017 | 0.0018 | 1.2 | 3 |
| 28 | 0.0017 | 0.01 | 0.18 | 0.009 | 0.018 | 0.0018 | 0.035 | 0.018 | 0.0018 | 1.4 | 4 |
| 29 | 0.0012 | tr.* | 0.17 | 0.009 | 0.010 | 0.0020 | 0.045 | 0.016 | 0.0019 | 1.7 | 3 |
| 30 | 0.0020 | 0.01 | 0.17 | 0.008 | 0.009 | 0.0021 | 0.045 | 0.016 | 0.0019 | 1.0 | 3 |
| 31 | 0.0025 | 0.01 | 0.17 | 0.009 | 0.008 | 0.0021 | 0.045 | 0.017 | 0.0020 | 0.88 | 4 |
| 32 | 0.0020 | 0.01 | 0.17 | 0.009 | 0.010 | 0.0020 | 0.031 | 0.017 | 0.0022 | 1.1 | 6 |
| 33 | 0.0019 | 0.01 | 0.18 | 0.009 | 0.009 | 0.0019 | 0.064 | 0.017 | 0.0021 | 1.2 | 6 |
| 34 | 0.0019 | 0.01 | 0.18 | 0.009 | 0.011 | 0.0020 | 0.082 | 0.018 | 0.0019 | 1.2 | 3 |
| 35 | 0.0012 | tr.* | 0.17 | 0.016 | 0.009 | 0.0021 | 0.043 | 0.018 | 0.0022 | 1.9 | 6 |
| 36 | 0.0018 | 0.01 | 0.17 | 0.028 | 0.009 | 0.0019 | 0.045 | 0.019 | 0.0019 | 1.4 | 4 |
| 37 | 0.0022 | 0.03 | 0.18 | 0.009 | 0.011 | 0.0022 | 0.044 | 0.021 | 0.0021 | 1.2 | 4 |

*tr.: below the lower limit of determination (Si < 0.008%)

TABLE 5

| | | Hot-rolling property | | |
|---|---|---|---|---|
| | | Value (%) of | | |
| Steel | Recrystallization | reduction | | |
| No. | temp. (° C.) | of area | Result | Category |
| 11 | 730 | 60 | pass | Inventive Example |
| 12 | 740 | 50 | pass | Inventive Example |
| 13 | 740 | 45 | pass | Inventive Example |
| 14 | — | 30 | fail | Comparative Example |
| 15 | 860 | 50 | pass | Comparative Example |
| 16 | 720 | 60 | pass | Comparative Example |
| 17 | 750 | 65 | pass | Comparative Example |
| 18 | 750 | 60 | pass | Inventive Example |
| 19 | 800 | 62 | pass | Inventive Example |
| 20 | 820 | 55 | pass | Inventive Example |
| 21 | 830 | 60 | pass | Inventive Example |
| 22 | 860 | 65 | pass | Comparative Example |
| 23 | — | 70 | fail | Comparative Example |
| 24 | 760 | 60 | pass | Inventive Example |
| 25 | 840 | 40 | pass | Comparative Example |
| 26 | 760 | 55 | pass | Inventive Example |
| 27 | 760 | 55 | pass | Inventive Example |
| 28 | — | 38 | fail | Comparative Example |
| 29 | 720 | 60 | pass | Inventive Example |
| 30 | 720 | 55 | pass | Inventive Example |
| 31 | 720 | 55 | pass | Comparative Example |
| 32 | 740 | 60 | pass | Inventive Example |
| 33 | 740 | 65 | pass | Inventive Example |
| 34 | 740 | 55 | pass | Comparative Example |
| 35 | 730 | 55 | pass | Inventive Example |
| 36 | 730 | 50 | pass | Comparative Example |
| 37 | 720 | 50 | pass | Comparative Example |

TABLE 6

| | | Cold- | | | | | |
|---|---|---|---|---|---|---|---|
| | | rolling | Annealing | | | | |
| | Steel | ratio | temp. | | | | |
| No. | No. | (%) | (° C.) | Δr | | Notes | Category |
| 41 | 11 | 70 | 750 | 0.03 | Pass | | Inventive Example |
| 42 | 11 | 80 | 750 | 0.02 | Pass | | Inventive Example |
| 43 | 11 | 85 | 750 | 0.01 | Pass | | Inventive Example |
| 44 | 11 | 90 | 750 | −0.13 | Fail | | Comparative Example |
| 45 | 12 | 70 | 750 | 0.02 | Pass | | Inventive Example |
| 46 | 12 | 80 | 750 | 0.01 | Pass | | Inventive Example |
| 47 | 12 | 90 | 750 | −0.12 | fail | | Comparative Example |
| 48 | 13 | 82 | 750 | 0.0.1 | pass | | Inventive Example |
| 49 | 15 | 82 | 830 | 0.00 | pass | hardness: mold | Comparative Example |
| | | | | | | was damaged | |
| | | | | | | during working | |
| 50 | 16 | 70 | 730 | 0.15 | fail | | Comparative Example |
| 51 | 16 | 80 | 730 | 0.13 | fail | | Comparative Example |
| 52 | 16 | 82 | 730 | 0.12 | fail | | Comparative Example |
| 53 | 17 | 82 | 760 | 0.01 | pass | wrinkles occurred | Comparative Example |
| | | | | | | during working | |
| 54 | 18 | 82 | 760 | 0.02 | pass | | Inventive Example |
| 55 | 19 | 82 | 810 | 0.01 | pass | | Inventive Example |
| 56 | 20 | 82 | 820 | 0.00 | pass | | Inventive Example |
| 57 | 21 | 82 | 830 | −0.01 | pass | | Inventive Example |
| 58 | 22 | 82 | 830 | 0.00 | pass | hardness: mold | Comparative Example |
| | | | | | | was damaged | |
| | | | | | | during working | |
| 59 | 24 | 82 | 760 | 0.01 | pass | | Inventive Example |
| 60 | 25 | 82 | 830 | 0.00 | pass | hardness: mold | Comparative Example |
| | | | | | | was damaged | |
| | | | | | | during working | |
| 61 | 26 | 82 | 760 | 0.00 | pass | | Inventive Example |
| 62 | 27 | 82 | 760 | −0.01 | pass | | Inventive Example |
| 63 | 29 | 82 | 740 | 0.01 | pass | | Inventive Example |
| 64 | 30 | 82 | 740 | 0.02 | pass | | Inventive Example |
| 65 | 31 | 82 | 740 | 0.02 | pass | wrinkles occurred | Comparative Example |
| | | | | | | during working | |
| 66 | 32 | 82 | 750 | −0.01 | pass | | Inventive Example |
| 67 | 33 | 82 | 750 | 0.02 | pass | | Inventive Example |
| 68 | 34 | 82 | 750 | 0.02 | pass | poor appearance | Comparative Example |
| | | | | | | (occurrence of | |
| | | | | | | many surface | |
| | | | | | | defects due | |
| | | | | | | to inclusion) | |
| 69 | 35 | 82 | 740 | 0.01 | pass | | Inventive Example |
| 70 | 36 | 82 | 740 | 0.01 | pass | hardness: mold | Comparative Example |
| | | | | | | was damaged | |
| | | | | | | during working | |
| 71 | 37 | 82 | 740 | −0.01 | pass | hardness: mold | Comparative Example |
| | | | | | | was damaged | |
| | | | | | | during working | |

As shown in Table 6, it is confirmed that only when all the composition ranges and the cold-rolling ratio of the present invention are satisfied, the cold-rolled steel sheet can have a Δr within +/−0.10 without other problems.

### INDUSTRIAL APPLICABILITY

Steel sheets having excellent surface properties can be obtained by suppressing deterioration of hot-rolling properties as much as possible and avoiding slab cracking by reducing the anisotropy and the amount of precipitate in a high-temperature range. The steel sheets are thus suitable for deep drawing and can be therefore provided as an excellent steel sheet for, for example, battery cases. Furthermore, the use of the steel sheets are not limited, and the steel sheets can be applied to various uses as a steel sheet having low anisotropy and satisfactory surface properties, for example, as a steel sheet for home appliances and a steel sheet for automobiles.

In addition, the steel sheets are low in the dependency of Δr on cold-rolling ratio, small in the variation of Δr due to changes in production conditions, and low in the anisotropy and is therefore an industrially useful material in the above-mentioned various uses.

1. A cold-rolled steel sheet composed of, by mass %, 0.0030% or less of C, 0.02% or less of Si, 0.15 to 0.19% of Mn, 0.020% or less of P, 0.015% or less of S, 0.0040% or less of N, 0.020 to 0.070% of Al, Nb in an amount of 1.00≦Nb/C (atomic equivalent ratio)≦5.0, and B in an amount of 1 ppm≦B-(11/14)N≦15 ppm (wherein, B and N denote the contents of the respective elements), and the balance being Fe and inevitable impurities, and having a planar anisotropy Δr of the r-value in the range of −0.10≦Δr≦0.10.

2. The cold-rolled steel sheet according to claim 1, wherein the cold-rolled steel sheet has a thickness of 0.25 mm or more and 0.50 mm or less.

3. A process for producing a cold-rolled steel sheet, comprising:
soaking a steel slab having a composition according to claim 1 at a temperature of 1050 to 1300° C. and then hot-rolling the slab at a finishing temperature of the Ar3 transformation point or higher;
cold-rolling the hot-rolled steel at a rolling ratio of 70 to 87%; and
annealing the cold-rolled steel on a continuous annealing line at an annealing temperature of from the recrystallization temperature to 830° C.

4. A battery having a battery case formed from a steel sheet according to claim 1.

5. (canceled)

6. A battery having a battery case formed from a steel sheet according to claim 2.

7. A process for producing a battery, comprising the step of forming a battery case by deep drawing of a steel sheet according to claim 1.

8. A process for producing a battery, comprising the step of forming a battery case by deep drawing of a steel sheet according to claim 2.
